(19) United States
(12) Patent Application Publication
(10) Pub. No.: US 2014/0308017 A1
(43) Pub. Date: Oct. 16, 2014

(54) IMAGING DEVICE, VIDEO RECORDING DEVICE, VIDEO DISPLAY DEVICE, VIDEO MONITORING DEVICE, VIDEO MONITORING SYSTEM, AND VIDEO MONITORING METHOD

(71) Applicants: Takuya Hashiguchi, Chiyoda-ku (JP); Takahiro Hiramatsu, Chiyoda-ku (JP)

(72) Inventors: Takuya Hashiguchi, Chiyoda-ku (JP); Takahiro Hiramatsu, Chiyoda-ku (JP)

(73) Assignee: Mitsubishi Electric Corporation, Chiyoda-ku (JP)

(21) Appl. No.: 14/360,165

(22) PCT Filed: Oct. 24, 2012
(86) PCT No.: PCT/JP2012/006791

§ 371 Date: May 22, 2014

(30) Foreign Application Priority Data
Nov. 25, 2011 (JP) 2011-257554

(51) Int. Cl. G11B 31/00; H04N 5/77

(52) U.S. Cl. CPC G11B 31/006; H04N 5/77
USPC 386/224

(57) ABSTRACT

In order to realize real-time monitoring of video data, a video display device in a conventional video monitoring system is required in advance to have capacity for decoding encoded video data equivalent to that in all of the imaging devices connected to the video display device, preferably to that in the maximum number of connectable imaging devices or to the maximum volume of data which is displayable. According to the present invention, when encoded video data recorded on a video recording device is read out and is displayed on a video display device, the video display device receives video data acquired by decoding, with an imaging device, the encoded video data read out from the video recording device. Therefore, since the video display device is not required to have capacity for decoding, the configuration thereof can be simplified independent of the number of connected imaging devices, and cost reduction thereof can be achieved.

### TECHNICAL FIELD

The present invention relates to an imaging device, a video recording device, a video display device, a video monitoring device, a video monitoring system, and a video monitoring method.

### BACKGROUND ART

There is known a video monitoring system comprised of an imaging device, such as a terminal with a camera, for imaging video and for outputting video data to be transmitted via a communication system (network), a video recording device (recorder) for recording the received video data, and a video display device (viewer) for displaying the received video data. In a video monitoring system, the number of imaging device to be connected is not necessarily one, but is often more than one. Therefore, since the volume of video data to be recorded in a video recording device is usually large, it is efficient that the data is recorded in a form of encoded video data which is encoded (compressed).

Video data is encoded, in some cases, by an imaging device that images video and transmits data thereof, or in other cases, by a video recording device that receives and records data. If the video data is encoded by the imaging device before transmitting it, not only efficient recording on the video recording device but also efficient transmission on a communication channel can be achieved.

A video display device decodes (decompresses) encoded video data that is directly received from the imaging device or that has been once recorded on the video recording device and is read out, retrieves the video data, and displays it (for example, see Patent Document 1).

### PRIOR ART DOCUMENTS

### Patent Documents

Patent Document 1: Japanese Unexamined Patent Application Publication No. 2010-068189

### SUMMARY OF THE INVENTION

### Problem that the Invention is to Solve

In order to realize real-time monitoring of video data, a video display device in a conventional video monitoring system is required in advance to have capacity for decoding encoded video data equivalent to that in all of the imaging devices connected to the video display device, preferably to that in the maximum number of connectable imaging devices or to the maximum volume of data which is displayable, thereby causing a problem of employing a large-scale configuration. In addition, when the number of imaging devices connected to the video display device is small, excessive investment in decoding capacity makes it difficult to reduce cost of the device.

The present invention has been made in order to solve the above-described problems, and an objective thereof is to reduce cost of a video display device by employing a configuration in which an imaging device not only encodes video data and transmits the encoded video data but also transmits decoded video data that has been received as encoded video data so that the configuration of the video display device can be simplified by eliminating the implementation of decoding capacity.

### Means for Solving the Problem

An imaging device according to the present invention includes an imaging unit that captures video and generates video data; an encoding unit that encodes the video data generated by the imaging unit and that generates encoded video data; a data generation unit that transforms the encoded video data which is generated, into encoded video data for communication; a communication unit that transmits the encoded video data for communication acquired by the transformation to a video recording device, that receives the encoded video data for communication from the video recording device, and that transmits video data for communication to a video display device; a data restoration unit that inverse-transforms the encoded video data for communication which is received, into encoded video data; a decoding unit that decodes the encoded video data acquired by the inverse-transformation and that generates video data; and a video generation unit that transforms the video data generated by the decoding unit into the video data for communication.

A video recording device according to the present invention includes a communication unit that receives encoded video data for communication from an imaging device and that transmits encoded video data for communication which is read out to an imaging device identified as a destination of transmission; a recording unit that records the encoded video data for communication which is received and that reads out encoded video data for communication requested by a video display device; and a control unit that generates storing information of the encoded video data for communication which is recoded, that identifies, based on the storing information, the imaging device serving as the destination of transmission to which the encoded video data for communication which is read out is transmitted, and that causes the recording unit to read out the encoded video data for communication which is requested.

A video display device of a video monitoring system according to the present invention includes a communication unit that receives video data for communication from an imaging device; a display unit that displays video data acquired from the video data for communication which is received; and a control unit that requests, based on storing information of encoded video data for communication generated by a video recording device, encoded video data for communication corresponding to desired video data specified with the intervention of input means, to the video recording device.

A video monitoring device according to the present invention includes a communication unit that receives encoded video data for communication and video data for communication from an imaging device, and that transmits encoded video data for communication which is read out to an imaging device identified as a destination of transmission; a recording unit that records the encoded video data for communication which is received and that reads out encoded video data for communication which is recorded; a display unit that displays video data acquired from the video data for communication which is received; and a control unit that generates storing information of the encoded video data for communication which is recoded, that identifies, based on the storing information, the imaging device serving as the destination of transmission to which encoded video data for communication corresponding to desired video data specified with the intervention of input means is transmitted, and that causes the recording unit to read out the encoded video data for communication corresponding to the desired video data which is specified.

A video monitoring system according to the present invention is configured with an imaging device, a video recording device, and a video display device, wherein the imaging device includes an imaging unit that captures video and generates video data; an encoding unit that encodes the video data generated by the imaging unit and that generates encoded video data; a data generation unit that transforms the encoded video data which is generated, into encoded video data for communication; a communication unit that transmits the encoded video data for communication acquired by the transformation to the video recording device, that receives the encoded video data for communication from the video recording device, and that transmits video data for communication to the video display device; a data restoration unit that inverse-transforms the encoded video data for communication which is received, into encoded video data; a decoding unit that decodes encoded video data acquired by the inverse-transformation and that generates video data; and a video generation unit that transforms the video data generated by the decoding unit into the video data for communication, wherein the video recording device includes a communication unit that receives encoded video data for communication from the imaging device and that transmits encoded video data for communication which is read out to an imaging device identified as a destination of transmission; a recording unit that records the encoded video data for communication which is received and that reads out encoded video data for communication requested by the video display device; and a control unit that generates storing information of the encoded video data for communication which is recoded, that identifies, based on the storing information, the imaging device serving as the destination of transmission to which the encoded video data for communication which is read out is transmitted, and that causes the recording unit to read out the encoded video data for communication which is requested, and wherein the video display device includes a communication unit that receives video data for communication from the imaging device; a display unit that displays video data acquired from the video data for communication which is received; and a control unit that requests, based on the storing information of the encoded video data for communication generated by the video recording device, encoded video data for communication corresponding to desired video data specified with the intervention of input means, to the video recording device.

A video monitoring system according to the present invention is configured with an imaging device and a video monitoring device, wherein the imaging device includes an imaging unit that captures video and generates video data; an encoding unit that encodes the video data generated by the imaging unit and that generates encoded video data; a data generation unit that transforms the encoded video data which is generated, into encoded video data for communication; a communication unit that transmits the encoded video data for communication acquired by the transformation to the video monitoring device, that receives the encoded video data for communication from the video monitoring device, and that transmits video data for communication to the video monitoring device; a data restoration unit that inverse-transforms the encoded video data for communication which is received, into encoded video data; a decoding unit that decodes encoded video data acquired by the inverse-transformation and that generates video data; and a video generation unit that transforms the video data generated by the decoding unit into the video data for communication, and wherein the video monitoring device includes a communication unit that receives encoded video data for communication and video data for communication from the imaging device, and that transmits encoded video data for communication which is read out to an imaging device identified as a destination of transmission; a recording unit that records the encoded video data for communication which is received and that reads out encoded video data for communication which is recorded; a display unit that displays video data acquired from the video data for communication which is received; and a control unit that generates storing information of the encoded video data for communication which is recoded, that identifies, based on the storing information, the imaging device serving as the destination of transmission to which encoded video data for communication corresponding to desired video data specified with the intervention of input means is transmitted, and that sends a request, to the recording unit, for the encoded video data for communication corresponding to the desired video data which is specified.

### Advantageous Effects of the Invention

In a video monitoring system according to the present invention, when encoded video data recorded on a video recording device is read out and is displayed on a video display device, the video display device receives video data acquired by decoding, with an imaging device, the encoded video data read out from the video recording device. Therefore, since the video display device is not required to have capacity for decoding, the configuration thereof can be simplified independent of the number of connected imaging devices, and cost reduction thereof can be achieved.

### BRIEF DESCRIPTION OF DRAWINGS

FIG. 1 is a connection diagram showing an example of a video monitoring system according to Embodiment 1 of the present invention.

FIG. 2 is a block configuration diagram showing an example of an imaging device, a video recording device, and a video display device which are connected to the video monitoring system according to Embodiment 1 of the present invention.

FIG. 3 is a flowchart showing an example of operation, in the video monitoring system according to Embodiment 1 of the present invention, during imaging of video by the imaging device through recording of the video on the video recording device.

FIG. 4 is a flowchart showing an example of operation, in the video monitoring system according to Embodiment 1 of the present invention, during imaging of video by the imaging device through displaying of the video on the video display device without the video recording device intervention.

FIG. 5 is a flowchart showing an example of operation, in the video monitoring system according to Embodiment 1 of the present invention, during recording of video by the image recording device through displaying of the video on the video display device.

FIG. 6 is a connection diagram showing an example of a video monitoring system according to Embodiment 2 of the present invention.

FIG. 7 is a block configuration diagram showing an example of an imaging device and a video recording/display device (video monitoring device) which are connected to the video monitoring system according to Embodiment 2 of the present invention.

FIG. 8 is a block configuration diagram showing an example of an imaging device, a video recording device, and a video display device which are connected to a video monitoring system according to Embodiment 3 of the present invention.

### MODE FOR CARRYING OUT THE INVENTION

In a video monitoring system according to the present invention, a video recording device transmits encoded video data recorded thereon to an imaging device, then the imaging device decodes the encoded video data received from the video recording device to retrieve video data and transmits it to a video display device, and then the video display device displays the video data received from the imaging device. Hereinafter, an example of the video monitoring system according to the present invention will be described.

### Embodiment 1

In Embodiment 1 of the present invention, explanation will be made on a video monitoring system configured with an imaging device, a video recording device, and a video display device.

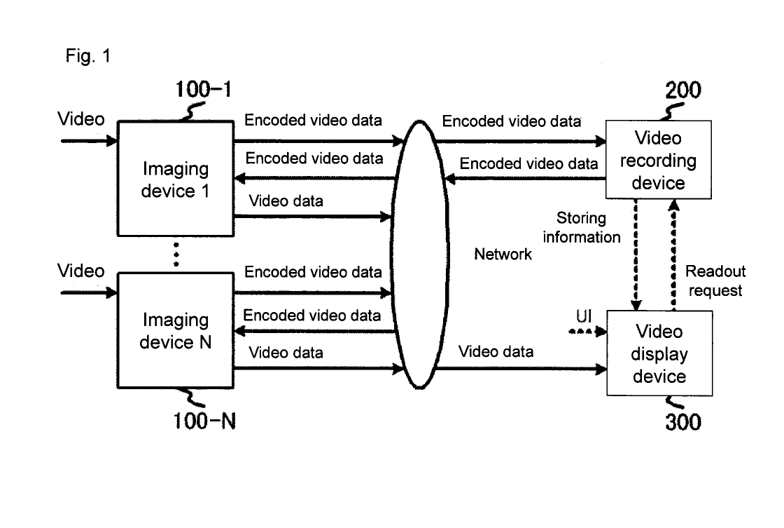

FIG. 1 is a connection diagram showing an example of the video monitoring system according to Embodiment 1 of the present invention. In the figure, plural imaging devices shown as a first imaging device (imaging device 100-1) through an N-th imaging device (imaging device 100-N) are connected to a video recording device 200 and a video display device 300 via a network. Each imaging device 100-n transmits encoded video data, acquired by encoding (compressing) video data that has been imaged, to the video recording device so as to be recorded thereon, and receives encoded video data read out from the video recording device. Also, each imaging device 100-n transmits to the video display device imaged video data as well as video data acquired by decoding (decompressing) encoded video data received from the video recording device. The video recording device 200 receives and records encoded video data from the imaging device, reads out encoded video data that has been requested, and transmits it to the imaging device. The video display device 300 displays video data received from the imaging device in a form without necessity of decoding, i.e. imaged video data and decoded video data.

Video data and encoded video data include at least information of the imaging device used for imaging and information of time when imaged, as supplemental information. The video display device acquires from the video recording device the supplemental information, as storing information, of encoded video data, and, based on the storing information, specifies desired video data with the intervention of input means such as a user interface (UI), for example, and requests the video recording device to read out the data. The video recording device reads out encoded video data corresponding to the requested video data, and transmits it to, for example, an imaging device that imaged the video data. The imaging device acquires video data by decoding the encoded video data received from the video recording device, and transmits it to the video display device. The video display device can receive and acquire the video data, via the imaging device, requested to the video recording device to be read out. Here, input/output of the storing information and the readout request may be made by directly connecting the video recording device and the video display device, or by connecting via the network. Note that, while the figure shows that the plural imaging devices are connected to the video recording device and the video display device, no problem occurs if single imaging device (N=1) is connected and operated.

In addition, it is assumed that transmitting and receiving of the encoded video data between the imaging device 100 and the video recording device 200 and those of the video data between the imaging device 100 and the video display device 300 are made on the connected network after transformed into a form suitable for communication. Hereinafter, video data to be transmitted or received is referred to as video data for communication, and encoded video data to be transmitted or received is referred to as encoded video data for communication.

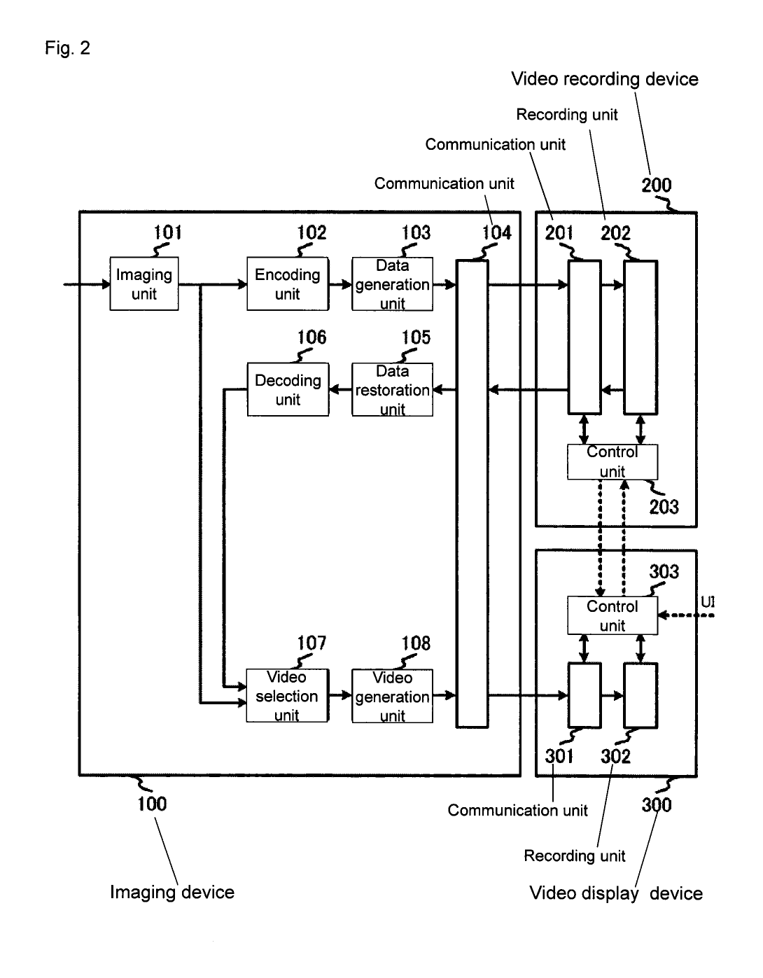

FIG. 2 is a block configuration diagram showing an example of the imaging device, the video recording device, and the video display device which are connected to the video monitoring system according to Embodiment 1 of the present invention. In FIG. 2, for the convenience of explanation, a configuration is shown in which single imaging device is connected, and the network between the imaging device, the video recording device, and the video display device, shown in the explanatory diagram in FIG. 1, is described simply. In the figure, the imaging device 100 includes an imaging unit (imaging means) 101, an encoding unit (encoding means) 102, a data generation unit (data generation means) 103, a communication unit (communication means) 104, a data restoration unit (data restoration means) 105, a decoding unit (decoding means) 106, a video selection unit (video selection means) 107, and a video generation unit (video generation means) 108. The video recording device 200 includes a communication unit (communication means) 201, a recording unit (recording means) 202, and a control unit (control means) 203. The video display device 300 includes a communication unit (communication means) 301, a display unit (display means) 302, and a control unit (control means) 303.

The imaging unit 101 in the imaging device 100 captures video via an optical system (for example, a lens; not shown), and generates video data. The encoding unit 102 encodes the video data generated by the imaging unit 101 to generate encoded video data. The data generation unit 103 transforms the encoded video data generated by the encoding unit 102 into encoded video data for communication which is suitable for communication. The communication unit 104 transmits the encoded video data for communication acquired by transformation with the data generation unit 103 to video recording device 200, transmits video data for communication acquired by transformation with the video generation unit 108, which will be described later, to the video display device 300, and receives encoded video data for communication from the video recording device 200. The data restoration unit 105 inverse-transforms the encoded video data for communication received by the communication unit 104 from the video recording device 200 into encoded video data. The decoding unit 106 decodes the encoded video data acquired by inverse-transformation with the data restoration unit 105 into video data. The video selection unit 107 selects video data to be displayed on the video display device from among the video data acquired by decoding with the decoding unit 106 and the video data generated by the imaging unit 101. The video generation unit 108 transforms the video data selected by the video selection unit 107 into video data for communication which is suitable for communication. The communication unit 104 transmits the video data for communication acquired by transformation with the video generation unit 108 to the video display device 300.

The communication unit 201 in the video recording device 200 receives from the imaging device 100 encoded video data for communication to be recorded, and transmits to the imaging device 100 encoded video data for communication corresponding to video data which is requested to be read out by the video display device 300 so as to be displayed thereon. The recording unit 202 records the encoded video data for communication to be recorded, which is received by the communication unit 201, and reads out, for the communication unit 201, the encoded video data for communication corresponding to the video data which is requested to be displayed. The control unit 203 generates storing information from supplemental information of the encoded video data for communication recoded on the recording unit 202, identifies an imaging device (destination), based on the storing information, to which the encoded video data for communication corresponding to the video data that is requested to be displayed is transmitted, causes the recording unit 202 to read out the encoded video data for communication corresponding to the video data that is requested to be displayed, and controls the encoded video data for communication which is read out, to be transmitted to the imaging device 100 identified as the destination. Note that the storing information may be transmitted to the video display device 300, or may be referred to by the video display device 300.

The communication unit 301 in the video display device 300 receives from the imaging device 100 the video data for communication corresponding to the video data which is requested to be read out so as to be displayed. The display unit 302 displays video data acquired from the video data for communication received by the communication unit 301. The control unit 303 requests, based on the storing information of the encoded video data for communication recorded on the video recording device 200, the video recording device 200 to read out encoded video data for communication corresponding to desired video data specified by the user interface (UI) serving as the input means (hereinafter, request to read out may be also referred to as readout request). The user interface (UI) serving as the input means may be one, for example, in which desired video data is selected from among an imaging time list showing correspondence between an imaging device and video data, or a list showing thumbnail or digest pictures for representing video data, each of which is made based on the storing information and the like generated by the video recording device 200.

Note that, in FIG. 2, while the storing information transmitted from the video recording device 200 to the video display device 300 and the readout request transmitted from the video display device 300 to the video recording device 200 are shown by dotted lines directly connecting between the control units 203 and 303, they may be exchanged via the communication units 201 and 301 if the communication channel intervenes therebetween.

Here, it is assumed that the communication unit 104 in the imaging device 100, the communication unit 201 in the video recording device 200, and the communication unit 301 in the video display device 300 can concurrently transmit or receive plural video data for communication or plural encoded video data for communication via a network having sufficient bandwidth and being capable of high-speed transmission.

The video selection unit 107 in the imaging device 100 selects video data to be displayed on the video display device 300 from among video data acquired by decoding with the decoding unit 106 and video data generated by the imaging unit 101. For example, if video data acquired by decoding with the decoding unit 106 is inputted when the video display device 300 needs a display and requests video data recorded on the video recording device 200, video data acquired by decoding with the decoding unit 106 may be preferentially selected than video data generated by the imaging unit 101. Also, for example, on the video display device 300, specifying combination output is possible whether or not to display video data acquired by decoding with the decoding unit 106 after reading out from the video recording device 200 encoded video data for communication which is already-recorded and whether or not to display video data generated by the imaging unit 101, and both data may be selected and transmitted so as to be displayed. In addition, video data imaged by the imaging unit 101 in the imaging device 100 may be always selected to be transmitted so as to be always displayed on the video display device 300.

Note that the imaging device 100 may be an imaging device having a configuration in which the video selection unit 107 is not included and video data, which is transmitted from the imaging device 100, to be displayed on the video display device 300 is limited to video data acquired by decoding with the decoding unit 106. That is, the imaging device 100 may include a variation having a configuration in which video data imaged by the imaging unit 101 is not transmitted as-is to the video display device 300.

Note that encoded video data for communication, read out from the video recording device 200, to be decoded by the decoding unit 106 may be encoded video data for communication that is imaged by an imaging device different from the imaging device which implements the concerned decoding unit 106 and that is recorded on the video recording device 200. For example, when plural video data are concurrently displayed corresponding to encoded video data for communication at times T1(≠T0) and T2(≠T1) recorded on the video recording device 200, including real-time (time: T0) video data imaged by the imaging unit 101 of the imaging device 100, or when plural video data are concurrently displayed corresponding to encoded video data for communication at times T1(≠T0), T2(≠T1), and T3(≠T2), plural video data imaged by the same imaging device at three different times may be concurrently displayed on the video display device by asking decoding thereof to the decoding unit of other imaging devices. Not limited to three different times, plural video data imaged by the same imaging device at four or more different times may be concurrently displayed on the video display device by similarly asking decoding thereof to the decoding unit of other imaging devices. Also, when an imaging device that does not implement the decoding unit is connected to a video monitoring system and is operated, video data corresponding to encoded video data recorded on the video recording device may be played-back on the video display device by similarly asking decoding thereof to the decoding unit of other imaging devices, and there is a possibility that, when introducing the video monitoring system, the system can be operated without replacing all of the imaging devices.

In this case, for example, by understanding decoding capacity of each of connected imaging devices 100, the video recording device 200 or the video display device 300 may identify an imaging device 100 to which decoding operation is asked. When the video display device 300 identifies the imaging device 100 to which decoding operation is asked, the device specifies both encoded video data for communication corresponding to the requested video data and the imaging device 100 identified as the destination of transmission.

In addition, although the video display device 300 does not need to include decoding function at all since the device receives video data generated by the imaging unit 101 or acquired by decoding with the decoding unit 106, the device by itself may perform decoding of part of encoded video data by, for example, having decoding units whose number is less the maximum number of connectable imaging devices, as long as implementation cost thereof is bearable. By employing such a configuration, connectivity with existing video recording devices and imaging devices may be ensured.

Next, operation will be described.

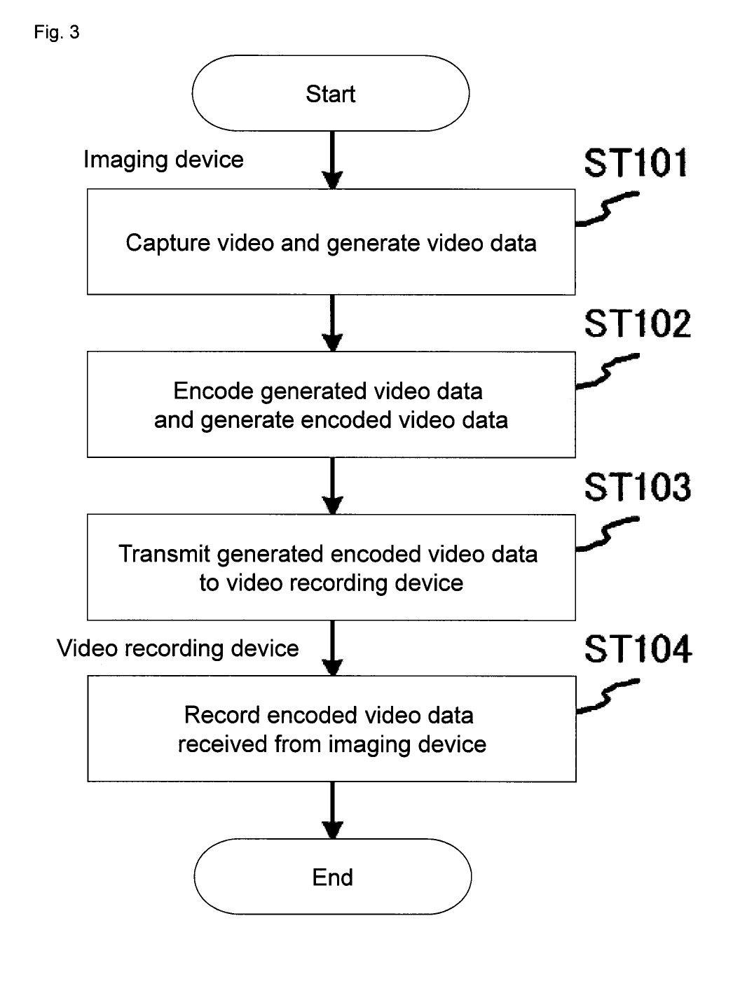

FIG. 3 is a flowchart showing an example of operation, in the video monitoring system according to Embodiment 1 of the present invention, during imaging of video by the imaging device through recording of the video by the video recording device.

In Step ST101 in the figure, the imaging unit 101 in the imaging device 100 generates video data by imaging video. For example, video data in a display color system such as YUV or RGB is generated.

In step ST102, the encoding unit 102 encodes video data imaged and generated by the imaging unit 101 to generate encoded video data. The data generation unit 103 performs processing such as grouping so as to divide the encoded video data generated by the encoding unit 102 into constant amount groups and adding header information to the data, adds supplemental information including information of the imaging device used for imaging and information of time when imaged, and transforms the data into encoded video data for communication having a form suitable for communication. Here, considering that the video data is used for video monitoring, the supplemental information may include information detected by sensors, image processing, and the like, such as moving object detection information and alarm information, for example. Also, a method for encoding video data in the encoding unit 102 is not limited to encoding methods such as, for example, JPEG, MPEG2, MPEG4, and H.246/AVC, but may be an encoding method which can be implemented, and similarly, the decoding unit 106 may employ a decoding method that corresponds to the encoding method and that can be implemented.

In step ST103, the communication unit 104 transmits to the video recording device the encoded video data for communication acquired by transformation with the data generation unit 103.

In step ST104, the communication unit 201 in the video recording device 200 receives the encoded video data for communication transmitted from the communication unit 104 in the imaging device 100, and the recording unit 202 records the encoded video data for communication which is received on a storage medium or the like, such as a hard disk drive (HDD), for example.

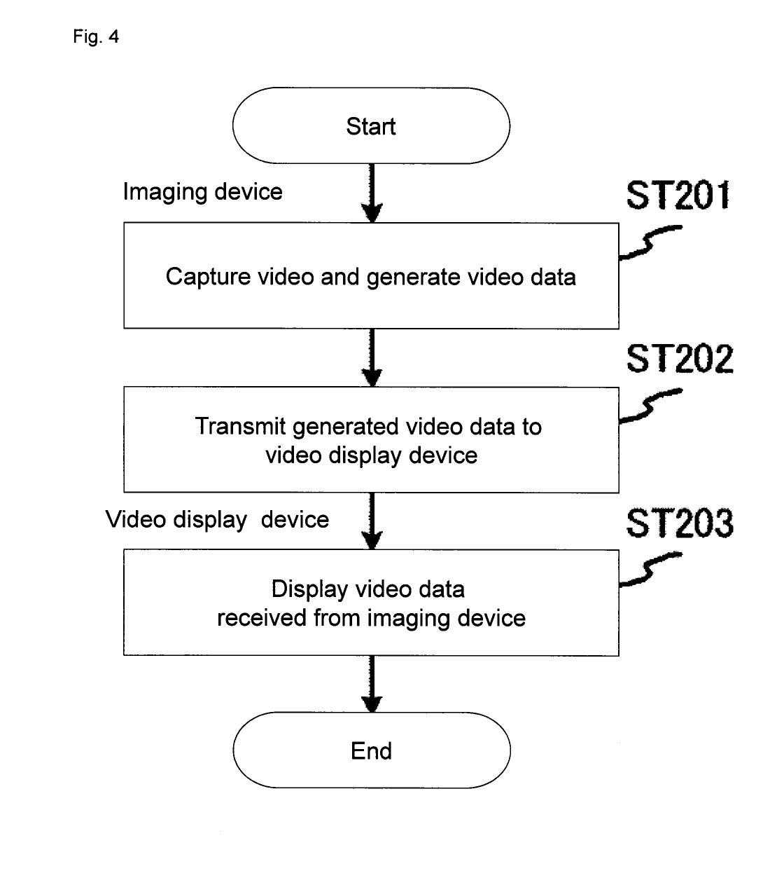

FIG. 4 is a flowchart showing an example of operation, in the video monitoring system according to Embodiment 1 of the present invention, during imaging of video by the imaging device through displaying of the video by the video display device without the video recording device intervention.

In step ST201 in the figure, the imaging unit 101 in the imaging device 100 images video and generates video data.

In step ST202, the video selection unit 107 selects video data imaged and generated by the imaging unit 101. The video generation unit 108 performs processing such as grouping so as to divide the video data selected by the video selection unit 107 into constant amount groups and adding header information to the data, and transforms the data into video data for communication having a form suitable for communication. The communication unit 104 transmits to the video display device 300 the video data for communication acquired by transformation with the video generation unit 108.

In step ST203, the communication unit 301 in the video display device 300 receives the video data for communication from the imaging device 100, and the display unit 302 displays video data acquired from the received video data for communication.

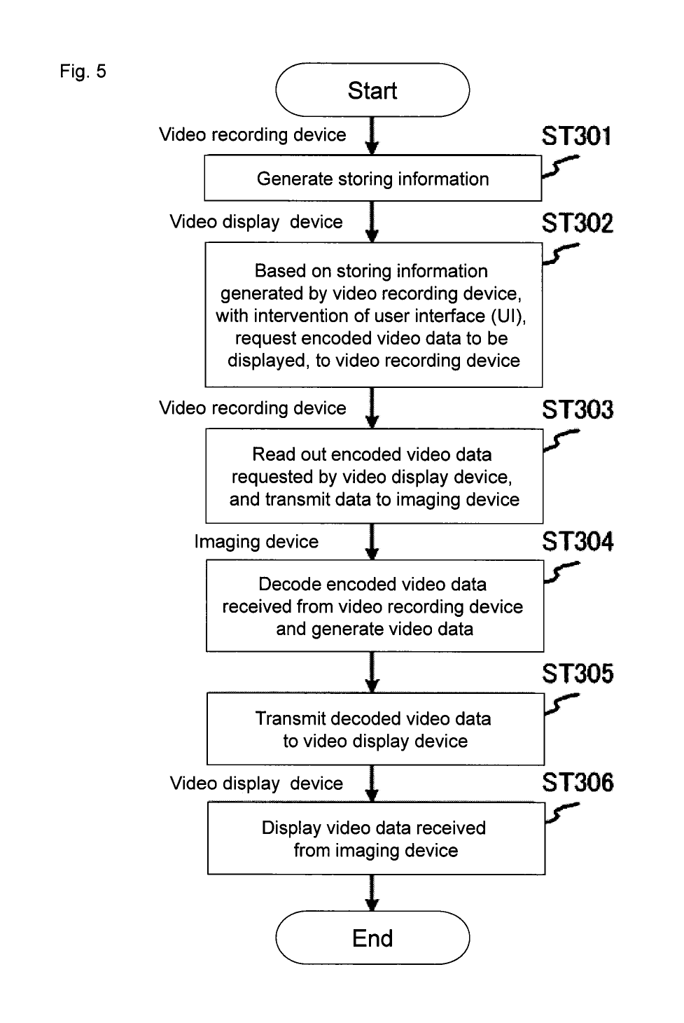

FIG. 5 is a flowchart showing an example of operation, in the video monitoring system according to Embodiment 1 of the present invention, during recording of video by the image recording device through displaying of the video by the video display device.

In step ST301 in the figure, the control unit 203 in the video recording device 200 generates storing information from the supplemental information of the encoded video data for communication that is received from the imaging device and that is recorded.

In step ST302, the control unit 303 in the video display device 300 issues, based on the storing information of the encoded video data for communication generated by the video recording device 200, a request to the video recording device 200 to read out encoded video data for communication corresponding to desired video data specified via the user interface (UI) serving as the input means.

In step ST303, the control unit 203 in the video recording device 200 receives the readout request from the video display device 300. The recording unit 202 reads out the encoded video data for communication corresponding to the video data which is requested to be read out. The communication unit 201 transmits the encoded video data for communication read out by the recording unit 202 to the imaging device 100 that has generated the concerned data and that has been identified as the destination. Note that, if the imaging device 100 which has generated the encoded video data for communication does not have the decoding unit 106, or if the imaging device 100 which has generated the concerned data is unclear, the communication unit 201 may specify another imaging device 100 that has the decoding unit 106 and that is not in operation, and may transmit the encoded video data for communication thereto.

In step ST304, the communication unit 104 in the imaging device 100 receives the encoded video data for communication transmitted from the video recording device 200. The data restoration unit 105 transforms the encoded video data for communication which is received, into encoded video data. The decoding unit 106 decodes the data acquired by inverse-transformation of the encoded video data for communication with the data restoration unit 105, to transform it into video data.

In step ST305, the video selection unit 107 selects video data decoded by the decoding unit 106, from among the video data decoded by the decoding unit 106 and video data imaged by the imaging unit 101. The video generation unit 108 performs processing such as grouping so as to divide the video data selected by the video selection unit 107 into constant amount groups and adding header information to the data, and transforms the data into video data for communication having a form suitable for communication. The communication unit 104 transmits to the video display device 300 the video data acquired by transformation with the video generation unit 108.

In step ST306, the communication unit 301 in the video display device 300 receives the video data for communication from the imaging device 100, and the display unit 302 displays video data acquired from the received video data for communication.

In this way, the video monitoring system according to Embodiment 1 of the present invention includes an imaging device capable of decoding encoded video data into video data; a video recording device which transmits, when readout of encoded video data which is recorded is requested by a video display device, the data to an identified imaging device and causes the device to decode the data, and which sends the decoded data to the video display device; and the video display device which requests, when desired video data to be displayed is specified, the data to the video recording device, which causes the video recording device to read out encoded video data corresponding to the video data, and which receives and displays the desired video data acquired by making the imaging device to decode the encoded data.

As described above, in the video monitoring system according to Embodiment 1 of the present invention, when encoded video data recorded on the video recording device is read out and is displayed on the video display device, the video display device receives video data acquired by decoding, with an imaging device, the encoded video data read out from the video recording device. Therefore, since the video display device is not required to have capacity for decoding, the configuration thereof can be simplified independent of the number of connected imaging devices, and cost reduction thereof can be achieved.

Also, in the video monitoring system according to Embodiment 1 of the present invention, when video data is encoded by a one-chip hardware codec, implemented in the imaging device, in which a decoding function is integrated, decoding function (decoder) which is not used can be effectively utilized without an additional implementation cost, in addition to using encoding function (encoder).

In addition, in the video monitoring system according to Embodiment 1 of the present invention, by identifying an imaging device, which is different from the imaging device that has sent the encoded video data received by the video recording device, as the destination of transmission, the video display device without having a decoding function can display plural video data imaged by the same imaging device at two, three, or more different times.

Furthermore, in the video monitoring system according to Embodiment 1 of the present invention, by identifying an imaging device, which is different from the imaging device that has sent the encoded video data received by the video recording device, as the destination of transmission, operational management, in which some of the imaging devices remain incapable of decoding encoded video data, can be made without replacing, at the same time, all of the imaging devices connected to the video monitoring system with imaging devices capable of decoding encoded video data.

### Embodiment 2

While the video monitoring system according to Embodiment 1 of the present invention is configured with an imaging device, a video recording device, and a video display device, a video monitoring system will be described in Embodiment 2 of the present invention, which is configured with an imaging device and a video recording/displaying device in which a video recording device and a video display device are integrated. The video recording/displaying device in which the video recording device and the video display device are integrated is referred to as a video monitoring device, and the video monitoring system is configured with the imaging device and the video monitoring device.

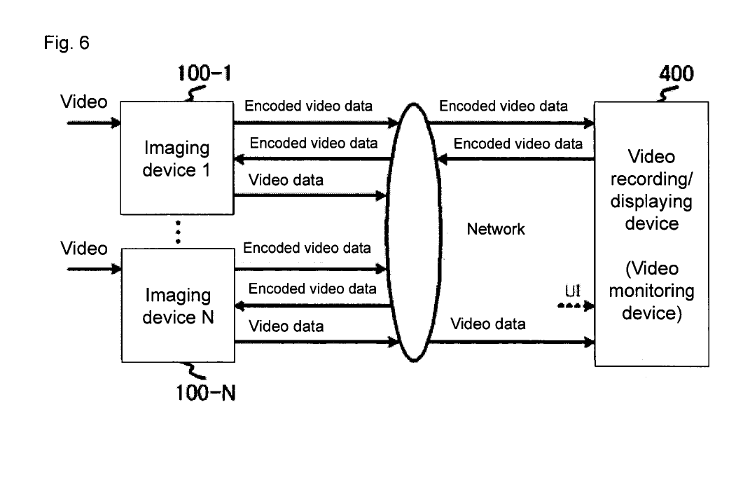

FIG. 6 is a connection diagram showing an example of the video monitoring system according to Embodiment 2 of the present invention. In the figure, plural imaging devices shown as a first imaging device (imaging device 100-1) through an N-th imaging device (imaging device 100-N) are connected to a video recording/displaying device 400 via a network. The configuration and operation of the imaging devices 100-1 through 100-N are the same with those of the imaging devices 100-1 through 100-N in the explanation of the video monitoring system according to Embodiment 1 of the present invention, to which the same numerals are allocated. The video recording/displaying device (video monitoring device) 400 has a configuration in which the video recording device 200 and the video display device 300 in the explanation of the video monitoring system according to Embodiment 1 of the present invention are integrated, and performs both operations of the video recording device 200 and the video display device 300. In FIG. 6, same with the expression in the connection diagram in FIG. 1, video data for communication which is video data to be transmitted or received and encoded video data for communication which is encoded video data to be transmitted or received are expressed in an abbreviated manner by omitting “for communication”.

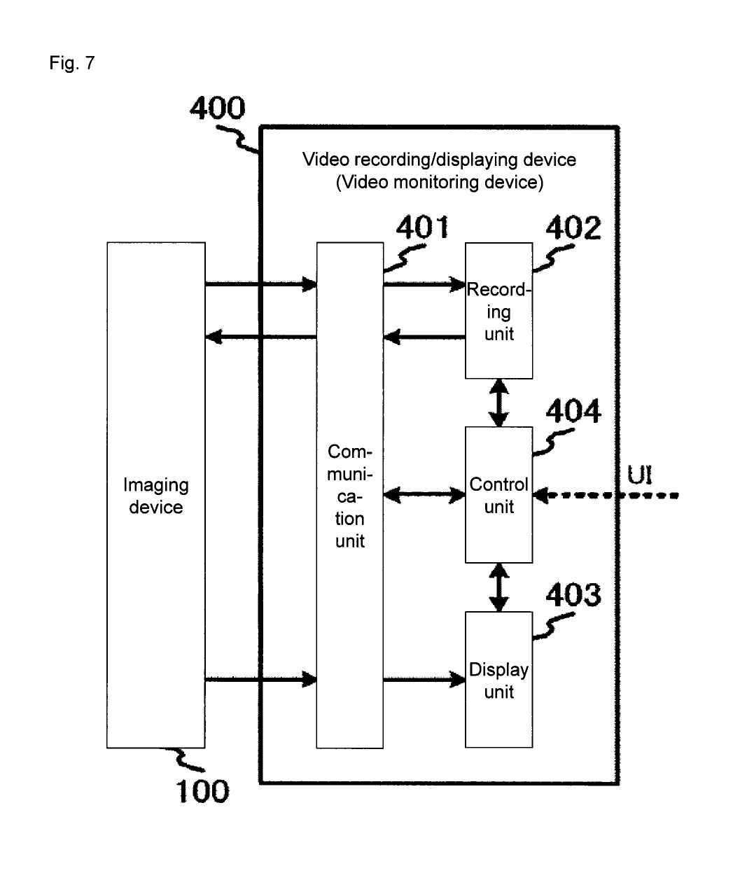

FIG. 7 is a block configuration diagram showing an example of the imaging device and the video recording/display device (video monitoring device) which are connected to the video monitoring system according to Embodiment 2 of the present invention. In FIG. 7, for the convenience of explanation, a configuration is shown in which single imaging device is connected, and the network between the imaging device and the video recording/display device, shown in the explanatory diagram in FIG. 6, is described simply. In the figure, the imaging device 100 is the same with the imaging device 100 in the explanation of the video monitoring system according to Embodiment 1 of the present invention, to which the same numeral is allocated. The video recording/displaying device 400 includes a communication unit (communication means) 401, a recording unit (recording means) 402, a display unit (display means) 403, and a control unit (control means) 404. Here, the configuration and operation of the recording unit 402 and the display unit 403 are the same with those of the recording unit 202 of the video recording device 200 and the display unit 302 of the video display device 300 in the explanation of the video monitoring system according to Embodiment 1 of the present invention. The communication unit 401 has a configuration in which the communication unit 201 of the video recording device 200 and the communication unit 301 of the video display device 300 in the explanation of the video monitoring system according to Embodiment 1 of the present invention are integrated, and performs both operations thereof. The control unit 404 has a configuration in which the control unit 203 of the video recording device 200 and the control unit 303 of the video display device 300 in the explanation of the video monitoring system according to Embodiment 1 of the present invention are integrated, and performs both operations thereof.

That is, the communication unit 401 receives from the imaging device encoded video data for communication and video data for communication, and transmits encoded video data for communication which is read out to an imaging device identified as the destination of transmission.

The control unit 404 generates storing information of the encoded video data for communication recorded on the recording unit 402, identifies an imaging device (destination), based on the storing information, to which encoded video data for communication corresponding to desired video data specified via the input means is transmitted, and causes the recording unit 402 to read out the encoded video data for communication corresponding to the desired video data which is specified.

In this way, the video monitoring system according to Embodiment 2 of the present invention includes an imaging device capable of decoding encoded video data into video data; and a video recording/displaying device (video monitoring device) which reads out, when desired video data to be displayed is specified, encoded video data which is recorded corresponding to the video data, which transmits the data to an identified imaging device and causes the device to decode the data, and receives and displays the desired video data.

As described above, in the video monitoring system according to Embodiment 2 of the present invention, advantageous effects can be obtained similar to those in the explanation of Embodiment 1 of the present invention if the video recording device and the video display device therein are deemed to be replaced by the integrated video recording/displaying device (video monitoring device).

Also, in the video monitoring system according to Embodiment 2 of the present invention, since the video recording device and the video display device are integrally configured as the video recording/displaying device, wirings necessary to connect between the video recording device and the video display device can be eliminated, thereby enabling a simple configuration.

### Embodiment 3

In both of the above-described Embodiment 1 and Embodiment 2 of the present invention, the imaging device transmits to the video display device video data imaged by the imaging device or acquired by decoding with the imaging device. In Embodiment 3 of the present invention, explanation of a video monitoring system will be made in which an imaging device transmits to a video display device video data imaged by the imaging device or acquired by decoding with the imaging device after scaling up or down the data.

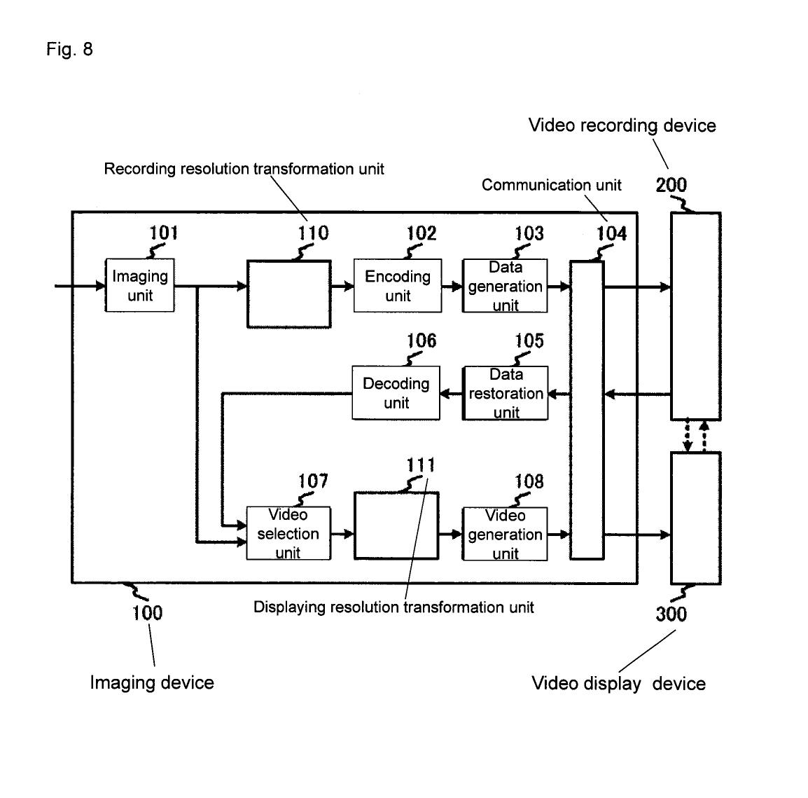

FIG. 8 is a block configuration diagram showing an example of an imaging device, a video recording device, and a video display device which are connected to the video monitoring system according to Embodiment 3 of the present invention. In the figure, the video recording device 200 and the video display device 300 are the same, respectively, with the video recording device 200 and the video display device 300 in the explanation of the video monitoring system according to Embodiment 1 of the present invention, to which the same numerals are allocated. The configuration and operation of the imaging device 100 are the same with those of the imaging device 100 in the explanation of the video monitoring system according to Embodiment 1 of the present invention, to which the same numeral is allocated, except that a recording resolution transformation unit (recording resolution transformation means) 110 and a displaying resolution transformation unit (displaying resolution transformation means) 111 are added thereto.

The recording resolution transformation unit 110 scales up or down video data imaged by the imaging unit 101 to acquire data with a specified size, and transmits the data to the encoding unit 102. The encoding unit 102 encodes the video data scaled up or down by the recording resolution transformation unit 110.

The displaying resolution transformation unit 111 scales up or down video data selected by the video selection unit 107, from among video data imaged by the imaging unit 101 and video data acquired by decoding with the decoding unit 106, to acquire data with a specified size, and transmits the data to the video generation unit 108. The video generation unit 108 performs processing such as grouping so as to divide the video data scaled up or down by the displaying resolution transformation unit 111 into constant amount groups and adding header information to the data, and transforms the data into video data for communication having a form suitable for communication.

Note that the imaging device which scales up or down video data to acquire data with a desired size may be applied to the video monitoring system according to Embodiment 2 of the present invention, that has the video recording/displaying device (video monitoring device) in which the video recording device and the video display device are integrated.

Also, while explanation is made here about the imaging device 100 that has both of the recording resolution transformation unit 110 and the displaying resolution transformation unit 111, the imaging device 100 may have a configuration in which either one of the resolution transformation units, for example only the displaying resolution transformation unit 111, is provided.

In some of the imaging device 100, resolution of video data to be imaged can be changed by setting it in the imaging unit 101. However, for example, if the video display device 300 directly changes settings of resolution of video data to be displayed, resolution of data to be encoded by the encoding unit 102 is also changed. Therefore, if settings of resolution of video data are changed just before the processing by the encoding unit 102 and the video generation unit 108, resolution at the recording and the display can be treated separately.

In this way, the video monitoring system according to Embodiment 3 of the present invention includes the imaging device which is capable of decoding encoded video data into video data and of transforming resolution of video data that is imaged and of video data that is acquired by decoding; the video recording device which transmits, when readout of encoded video data which is recorded is requested by the video display device, the data to an identified imaging device, causes the device to decode the data, and sends the decoded data to the video display device; and the video display device which issues, when desired video data to be displayed is specified, a request to the video recording device, causes the video recording device to read out encoded video data corresponding to the video data, and receives and displays the desired video data decoded by the imaging device.

Also, the video monitoring system according to Embodiment 3 of the present invention includes the imaging device which is capable of decoding encoded video data into video data and of transforming resolution of video data that is imaged and of video data that is acquired by decoding; and the video recording/displaying device (video monitoring device) which reads out, when desired video data to be displayed is specified, encoded video data which is recorded corresponding to the video data, transmits the data to an identified imaging device and causes the device to decode the data, and receives and displays the desired video data.

As described above, in the video monitoring system according to Embodiment 3 of the present invention, advantageous effects can be obtained similar to those in the explanation of Embodiment 1 of the present invention.

Also, in the video monitoring system according to Embodiment 3 of the present invention, advantageous effects can be obtained similar to those in the explanation of Embodiment 2 of the present invention, if the video recording/displaying device (video monitoring device) is applied in which the video recording device and the video display device are integrated as shown in Embodiment 2 of the present invention.

In addition, in the video monitoring system according to Embodiment 3 of the present invention, as the recording resolution transformation unit 110 and the displaying resolution transformation unit 111 are added to the configuration of the imaging device 100, the video display device 300 can receive video data which is decoded and is scaled up or down to acquire data with a desired size. Therefore, since the video display device 300 is not required to have capacity for scaling up or down, the configuration thereof can be simplified independent of the number of connected imaging devices, and cost reduction thereof can be achieved.

Furthermore, in the video monitoring system according to Embodiment 3 of the present invention, when the recording resolution transformation unit 110 scales down the size of video data, the size of encoded video data encoded by the encoding unit 102 is reduced, and when the displaying resolution transformation unit 111 scales down the size of video data, the size of video data for communication transformed by the video generation unit 108 is reduced. Therefore, an advantageous effect is obtained in which the amount of data to be transmitted via the network can be reduced.

Note that the video recording device 200, the video display device 300, and the video recording/displaying device (video monitoring device) 400 in the video monitoring system according to the embodiments of the present invention described above may be configured with a computer and may be operated by a program stored in a storage medium.

As described above, in the video monitoring system according to the present invention, when encoded video data recorded on the video recording device is read out and is displayed on the video display device, the video display device receives video data acquired by decoding, with an imaging device, the encoded video data read out from the video recording device. Therefore, since the video display device is not required to have capacity for decoding, the configuration thereof can be simplified independent of the number of connected imaging devices, and cost reduction thereof can be achieved.

In the video monitoring system according to the present invention, when video data is encoded by a one-chip hardware codec, implemented in the imaging device, in which a decoding function is integrated, decoding function (decoder) which is not used can be effectively utilized without an additional implementation cost, in addition to using encoding function (encoder).

In the video monitoring system according to the embodiments of the present invention, by identifying an imaging device, which is different from the imaging device that has sent the encoded video data received by the video recording device, as the destination of transmission, the video display device without having a decoding function can display plural video data imaged by the same imaging device at two, three, or more different times.

In the video monitoring system according to the embodiments of the present invention, by identifying an imaging device, which is different from the imaging device that has sent the encoded video data received by the video recording device, as the destination of transmission, operational management, in which some of the imaging devices remain incapable of decoding the encoded video data, can be made without replacing, at the same time, all of the imaging devices connected to the video monitoring system with imaging devices capable of decoding encoded video data.

In the video monitoring system according to the embodiments of the present invention, since the video recording device and the video display device are integrally configured as the video recording/displaying device, wirings necessary to connect between the video recording device and the video display device can be eliminated, thereby enabling a simple configuration.

In the video monitoring system according to the embodiments of the present invention, as the recording resolution transformation unit and the displaying resolution transformation unit are added to the configuration of the imaging device, the video display device can receive video data which is decoded and is scaled up or down to acquire data with a desired size. Therefore, since the video display device is not required to have capacity for scaling up or down, the configuration thereof can be simplified independent of the number of connected imaging devices, and cost reduction thereof can be achieved.

In the video monitoring system according to the embodiments of the present invention, when the recording resolution transformation unit scales down the size of video data, the size of encoded video data encoded by the encoding unit is reduced, and when the displaying resolution transformation unit scales down the size of video data, the size of video data for communication transformed by the video generation unit is reduced. Therefore, an advantageous effect is obtained in which the amount of data to be transmitted via the network can be reduced.

### INDUSTRIAL APPLICABILITY

As described above, an imaging device, a video recording device, a video display device, a video monitoring device, a video monitoring system, and a video monitoring method according to the present invention are useful for a video monitoring system whose configuration is simplified by eliminating the implementation of decoding capacity to a video display device thereby reducing cost thereof, and is especially suitable for a small-scale video monitoring system.

### REFERENCE NUMERALS

100, 100-1 through 100-N: imaging devices; 101: imaging unit; 102: encoding unit; 103: data generation unit; 104: communication unit; 105: data restoration unit; 106: decoding unit; 107: video selection unit; 108: video generation unit; 110: recording resolution transformation unit; 111: displaying resolution transformation unit; 200: video recording device; 201: communication unit; 202: recording unit; 203: control unit; 300: video display device; 301: communication unit; 302: display unit; 303: control unit; 400: video recording/displaying device (video monitoring device); 401: communication unit; 402: recording unit; 403: display unit; and 404: control unit.

1. An imaging device comprising:
an imaging unit capturing video, and generating video data;
an encoding unit encoding the video data generated by the imaging unit, and generating encoded video data;
a data generation unit transforming the encoded video data being generated into encoded video data for communication;
a communication unit transmitting the encoded video data for communication being transformed to a video recording device, receiving the encoded video data for communication from the video recording device, and transmitting video data for communication to a video display device;
a data restoration unit inverse-transforming the encoded video data for communication being received into the encoded video data;
a decoding unit decoding the encoded video data being inverse-transformed, and generating the video data; and
a video generation unit transforming the video data generated by the decoding unit into the video data for communication.

2. The imaging device of claim 1, comprising
a video selection unit selecting video data from among the video data generated by the imaging unit and the video data generated by the decoding unit,
the video generation unit transforming the video data selected by the video selection unit into the video data for communication.

3. The imaging device of claim 1, comprising
a recording resolution transformation unit transforming resolution of the video data generated by the imaging unit,
the encoding unit encoding the video data whose resolution is transformed by the recording resolution transformation unit.

4. The imaging device of claim 1, comprising
a displaying resolution transformation unit transforming resolution of the video data generated by the imaging unit,
the video generation unit transforming the video data whose resolution is transformed by the displaying resolution transformation unit into the video data for communication.

5. The imaging device of claim 2, comprising
a displaying resolution transformation unit transforming resolution of the video data selected by the video selection unit,
the video generation unit transforming the video data whose resolution is transformed by the displaying resolution transformation unit into the video data for communication.

6. A video recording device comprising:
a communication unit that receives encoded video data for communication from an imaging device and that transmits encoded video data for communication which is read out to an imaging device identified as a destination of transmission;
a recording unit that records the encoded video data for communication which is received and that reads out encoded video data for communication requested by a video display device; and
a control unit that generates storing information of the encoded video data for communication which is recoded, that identifies, based on the storing information, the imaging device serving as the destination of transmission to which the encoded video data for communication which is read out is transmitted, and that causes the recording unit to read out the encoded video data for communication which is requested.

7. The video recording device of claim 6, wherein the control unit identifies an imaging device which has sent the encoded video data for communication read out from the recording unit, as the imaging device to be the destination of transmission.

8. The video recording device of claim 6, wherein the control unit identifies an imaging device which is different from an imaging device that has sent the encoded video data for communication read out from the recording unit, as the imaging device to be the destination of transmission.

9. A video display device comprising:
a communication unit that receives video data for communication from an imaging device;
a display unit that displays video data acquired from the video data for communication which is received; and
a control unit that requests, based on storing information of encoded video data for communication generated by a video recording device, encoded video data for communication corresponding to desired video data specified with the intervention of input means, to the video recording device.

10. A video monitoring device comprising:
a communication unit receiving encoded video data for communication and video data for communication from an imaging device, and transmitting the encoded video data for communication being read out to an imaging device specified as a destination;
a recording unit recording the encoded video data for communication being received and reading out the encoded video data for communication being recorded;
a display unit displaying video data acquired from the video data from communication being received; and
a control unit generating storing information of the encoded video data for communication being recorded, specifying, based on the storing information, an imaging device to transmit the encoded video data for communication corresponding to the desired video data designated using input means as a destination, and controlling readout, by the recording unit, of the encoded video data for communication corresponding to the desired video data being designated.

11. A video monitoring system comprising an imaging device, a video recording device, and a video display device, wherein the imaging device includes
an imaging unit that captures video and generates video data;
an encoding unit that encodes the video data generated by the imaging unit and that generates encoded video data;
a data generation unit that transforms the encoded video data which is generated, into encoded video data for communication;
a communication unit that transmits the encoded video data for communication acquired by the transformation to the video recording device, that receives the encoded video data for communication from the video recording device, and that transmits video data for communication to the video display device;
a data restoration unit that inverse-transforms the encoded video data for communication which is received, into encoded video data;
a decoding unit that decodes encoded video data acquired by the inverse-transformation and that generates video data; and
a video generation unit that transforms the video data generated by the decoding unit into the video data for communication,
wherein the video recording device includes
a communication unit that receives encoded video data for communication from the imaging device and that transmits encoded video data for communication which is read out to an imaging device identified as a destination of transmission;
a recording unit that records the encoded video data for communication which is received and that reads out encoded video data for communication requested by the video display device; and
a control unit that generates storing information of the encoded video data for communication which is recoded, that identifies, based on the storing information, the imaging device serving as the destination of transmission to which the encoded video data for communication which is read out is transmitted, and that causes the recording unit to read out the encoded video data for communication which is requested, and wherein the video display device includes
a communication unit that receives video data for communication from the imaging device;
a display unit that displays video data acquired from the video data for communication which is received; and
a control unit that requests, based on the storing information of the encoded video data for communication generated by the video recording device, encoded video data for communication corresponding to desired video data specified with the intervention of input means, to the video recording device.

12. The video monitoring system of claim 11, wherein
the imaging device further includes a video selection unit that selects video data from among the video data generated by the imaging unit and the video data generated by the decoding unit; and
the video generation unit transforms the video data selected by the video selection unit into the video data for communication.

13. A video monitoring system comprising an imaging device and a video monitoring device,
the imaging device including
an imaging unit capturing video, and generating video data;
an encoding unit encoding the video data generated by the imaging unit, and generating encoded video data;
a data generation unit transforming the encoded video data being generated into encoded video data for communication;
a communication unit transmitting the encoded video data for communication being transformed to a video recording device, receiving the encoded video data for communication from the video recording device, and transmitting video data for communication to a video display device;
a data restoration unit inverse-transforming the encoded video data for communication being received into encoded video data;
a decoding unit decoding the encoded video data being inverse-transformed, and generating the video data; and
a video generation unit transforming the video data generated by the decoding unit into the video data for communication,
the video monitoring device including
a communication unit receiving the encoded video data for communication and the video data for communication from an imaging device, and transmitting the encoded video data for communication being read out to an imaging device specified as a destination;
a recording unit recording the encoded video data for communication being received and reading out the encoded video data for communication being recorded;
a display unit displaying the video data acquired from the video data from communication being received; and
a control unit generating storing information of the encoded video data for communication being recorded, specifying, based on the storing information, an imaging device to transmit the encoded video data for communication corresponding to the desired video data designated using input means as a destination, and controlling readout, by the recording unit, of the encoded video data for communication corresponding to the desired video data being designated.

14. The video monitoring system of claim 13,
the imaging device including
a video selection unit selecting the video data from among the video data generated by the imaging unit and the video data generated by the decoding unit; and
the video generation unit transforming the video data selected by the video selection unit into the video data for communication.

15. A video monitoring method comprising steps of:
acquiring video and generating video data, by an imaging device;
encoding the video data which is generated and generating encoded video data;
transforming the encoded video data which is generated, into encoded video data for communication;
transmitting the encoded video data for communication acquired by the transformation to a video recording device;
receiving, by the video recording device, the encoded video data for communication from the imaging device;
recording the encoded video data for communication which is received;
generating storing information of the encoded video data for communication which is recorded;
requesting, by a video display device, based on the storing information of the encoded video data for communication generated by the video recording device, encoded video data for communication corresponding to desired video data specified with the intervention of input means;
identifying, by the video recording device, based on the storing information, an imaging device serving as a destination of transmission to which the encoded video data for communication which is read out is transmitted, and reading out, by the video recording device, the encoded video data for communication which is requested by the video display device;
transmitting the encoded video data for communication which is read out to the imaging device identified as the destination of transmission;
receiving, by the imaging device, the encoded video data for communication from the video recording device;
inverse-transforming the encoded video data for communication which is received, into encoded video data;
generating video data by decoding the encoded video data acquired by the inverse-transformation;
transforming the video data acquired by the decoding into video data for communication;
transmitting the video data for communication acquired by the transformation to the video display device;
receiving, by the video display device, the video data for communication from the imaging device; and
displaying video data acquired from the video data for communication which is received.

16. A video monitoring method comprising steps of:
acquiring video and generating video data, by an imaging device;
encoding the video data which is generated and generating encoded video data;
transforming the encoded video data which is generated, into encoded video data for communication;
transmitting the encoded video data for communication acquired by the transformation to a video monitoring device;
receiving, by the video monitoring device, the encoded video data for communication from the imaging device;
recording the encoded video data for communication which is received;
generating storing information of the encoded video data for communication which is recorded;
identifying, based on the storing information which is generated, an imaging device serving as a destination of transmission to which encoded video data for communication corresponding to desired video data specified with the intervention of input means, and reading out the encoded video data for communication corresponding to the desired video data which is specified;
transmitting the encoded video data for communication which is read out to the imaging device identified as the destination of transmission;
receiving, by the imaging device, the encoded video data for communication from the video monitoring device;
inverse-transforming the encoded video data for communication which is received, into encoded video data;
generating video data by decoding the encoded video data acquired by the inverse-transformation;
transforming the video data acquired by the decoding into video data for communication;
transmitting the video data for communication acquired by the transformation to the video monitoring device;
receiving, by the video monitoring device, the video data for communication from the imaging device; and
displaying video data acquired from the video data for communication which is received.
